(19) United States
(12) Patent Application Publication
(10) Pub. No.: US 2011/0313954 A1
(43) Pub. Date: Dec. 22, 2011

(54) COMMUNITY MODEL BASED POINT OF INTEREST LOCAL SEARCH

(75) Inventors: Feng Zhao, ISSAQUAH, WA (US); Nicholas D. Lane, Hanover, NH (US); Dimitrios Lymperopoulos, Belleuve, WA (US); Jing Zhao, Beijing (CN)

(73) Assignee: Microsoft Corporation, Redmond, WA (US)

(21) Appl. No.: 12/819,080

(22) Filed: Jun. 18, 2010

(51) Int. Cl. G06F 17/30; G06F 15/18

(52) U.S. Cl. 706/12; 707/769; 707/728; 707/E17.014

(57) ABSTRACT

The present disclosure describes a community model based point of interest local search platform. Specifically, logs of users that store selections while accessing a point of interest application are loaded into a database. The logs are of users that have similar demographic or other community attributes. The logs are then mined for contextual parameters, including, but not limited to time of day, day of week, distance, activity, environment, popularity, and personal preferences. The point of interest selections are then mapped to a multi-dimensional map where each dimension corresponds to a contextual parameter. Clusters are evaluated by a classifier and classes of users of the community are identified. When a user then queries the community model based point of interest local search platform, contextual parameters are submitted with the query, relevant classes identified, and the corresponding point of interest information is displayed to the user.

### BACKGROUND

Presently, the internet is searched for a wide range of reasons. In some cases, a user is engaged in information discovery where the user wants to learn about the context of a particular topic. In other cases, a user is already familiar with a context and is searching for actionable information. For information discovery, the criteria that constitute relevance are not as strict as in the case of a search for actionable information. In the former, a user may broadly determine whether something is relevant based on where the user's knowledge is weak. However, in a search for actionable information, the information desired is directed to a very particular set of circumstances.

Local search, that is search on points of interest near the present location of a user, is an example of a search for actionable information. A user has a particular activity he or she wishes to engage in, such as dining, and in such case the user is seeking for a nearby restaurant for the purpose of dining.

The actual decision process a user engages in to seek actionable information usually does not match present local search techniques. For example, a local search technique may rank results by price, by ratings, by distance, or a number of other factors, but such rankings do not take into account the dynamic nature of a user's preferences. While a user may be in fact be motivated by price, ratings, distance and the like, the degree that each of these factors affect a user's decisions can change over time, or context, or other factors. Present local search techniques display the same set of search results in all of these cases for a given query and a given location independently of the context of the query.

For example, present local search techniques do not take time of day into account. In the morning, when a user searches for a restaurant, the user is more likely to desire a breakfast establishment. In contrast, in the evening, the user is more likely to desire a restaurant specializing in dinners. Similarly, if the user is walking, the user is likely to be interested in establishments within a couple of blocks, but if the user is driving, the user is likely to be willing to search a radius of several miles.

By way of another example, present local search techniques do not take the device the user is performing search on into account, and do not take advantage of differences in devices. Although searching for actionable information can take place on any device that is connected to the internet, a user of a mobile client is much more likely, than a desktop computer-bound user, to engage in this type of search. The context of the user is more important when the user is on the go and uses a mobile device when compared to sitting in his living room in front of his PC. In the former, a user that searches for “Italian Restaurants” is most probably trying to find a nearby restaurant to have dinner. In other words the user seeks the necessary information to make an informed decision about what to do next. In the latter, a user that searches for “Italian Restaurants” might want to discover restaurants to visit in the future. In this case, the current user's context is not as important as before. In either case, present search techniques do not make use of platform information.

In general, present local search techniques do not provide a point of interest search infrastructure that takes the dynamic user decision process into account, thereby providing more relevant and therefore more actionable search results.

### SUMMARY

This application discloses a community model based point of interest local search platform. Specifically, this application discloses analyzing records of users engaged in search, reviewing subsequent actions, and creating a multi-dimensional model of this activity. From this multi-dimensional model, this application further discloses seeking clusters of activity potentially denoting a subset community of users with similar habits, and providing point of interest local search results based on this multi-dimensional model.

This application discloses embodiments relating to a community model based point of interest local search, including, but not limited to: (1) various contextual parameters constituting a factor effecting local search, (2) various points of interest, (3) various multi-dimensional map metrics, (4) various techniques to measure search result relevance, (5) collecting user feedback and (6) ranking and scoring search results.

This application also discloses embodiments relating to importing and classifying data to create a data store supporting community model based point of interest local search including, but not limited to: (1) importing usage data and identifying classes of similar users, (2) various multi-dimensional map metrics and (3) various optimizations.

This application furthermore discloses both client and server embodiments comprising a community model based point of interest local search platform.

This summary is provided to introduce concepts relating to community model based point of interest local search. These techniques are further described below in the detailed description. This summary is not intended to identify essential features of the claimed subject matter, nor is it intended for use in determining the scope of the claimed subject matter.

### BRIEF DESCRIPTION OF THE DRAWINGS

Non-limiting and non-exhaustive examples are described with reference to the following figures. In the figures, the left-most digit(s) of a reference number identifies the Fig. in which the reference number first appears. The use of the same reference numbers in different figures indicates similar or identical items or features.

FIG. 1 is a top-level system diagram supporting community model based point of interest local search.

FIG. 2 is an exemplary hardware environment supporting community model based point of interest local search.

FIG. 3 is an exemplary mobile client for community model based point of interest local search.

FIG. 4A is a two dimensional example of a map used to classify points of interest.

FIG. 4B is a multi-dimensional example of a map used to classify points of interest.

FIG. 5 is an exemplary server-side software infrastructure supporting community model based point of interest local search.

FIG. 6 is an exemplary embodiment to load point of interest access information into a data store supporting community model based point of interest local search.

FIG. 7 is an exemplary embodiment to query point of interest information based on a community model.

### DETAILED DESCRIPTION

### Overview

This application relates to point of interest local search. Specifically, this application relates to community model based point of interest local search.

Local search is a search for locations of facilities to perform some activity or errand within an actionable radius of a user performing a search. If the user is on foot, the radius may be a few blocks. If the user is in a car, the radius may be several miles. In some circumstances, a user may be proximate to an item, but may not access that item. For example, if a user in on the 12^{th} floor of a building, and a facility is directly overhead, but on the 13^{th} floor, in a private area, then in some instances, that item would be considered proximate but not local.

A point of interest is any location or facility that a user might search for to perform some activity or errand. Points of interest include, but are not limited to, places of business, private residences, tourist attractions and government installations. Specific examples can include, but are not limited to, restaurants, dry cleaners, libraries, internet cafes.

A community model is a model that identifies similar users, i.e., users in the same community, according to some set of attributes. Attributes can be specific to a user including, but not limited to, demographic information such as age and gender, and belonging to an interest group or social network. User attributes need not be demographic in nature, but may include geolocation or user transportation activity (i.e. whether the user is walking or driving). Other attributes may be specific to an item to be searched for including, but not limited to popularity of a business, or average cost of a meal at a restaurant. Yet other attributes may be global attributes not specific to either user or item of search including, but not limited to, local weather, local traffic conditions or time of day. Some of these attributes may be contextual parameters. A contextual parameter is a parameter that indicates a likelihood that a user will perform a particular activity or errand. Contextual parameters are often dynamic, their values differing depending on the particular circumstances of the user. Contextual parameters can include, but are not limited to, the time of the day, time of the week, and the user's geolocation or distance from a location. Other contextual parameters may be categories including, but not limited to, environmental factors, activity currently engaged in, and current popularity trends. Yet other contextual parameters may be static parameters, such as predetermined personal preferences, or values of parameters of a social network the user is affiliated with. Users with similar values of contextual parameters may denote sub-communities, or classes, within a community.

Any sensor or combination of sensors that can send information to a user device may provide contextual parameters. The sensor or combinations of sensors may either by on the user device or external to a user device. Examples include, but are not limited to Global Positioning Satellite (GPS) data, an internal system time clock and external weather reports from a web feed.

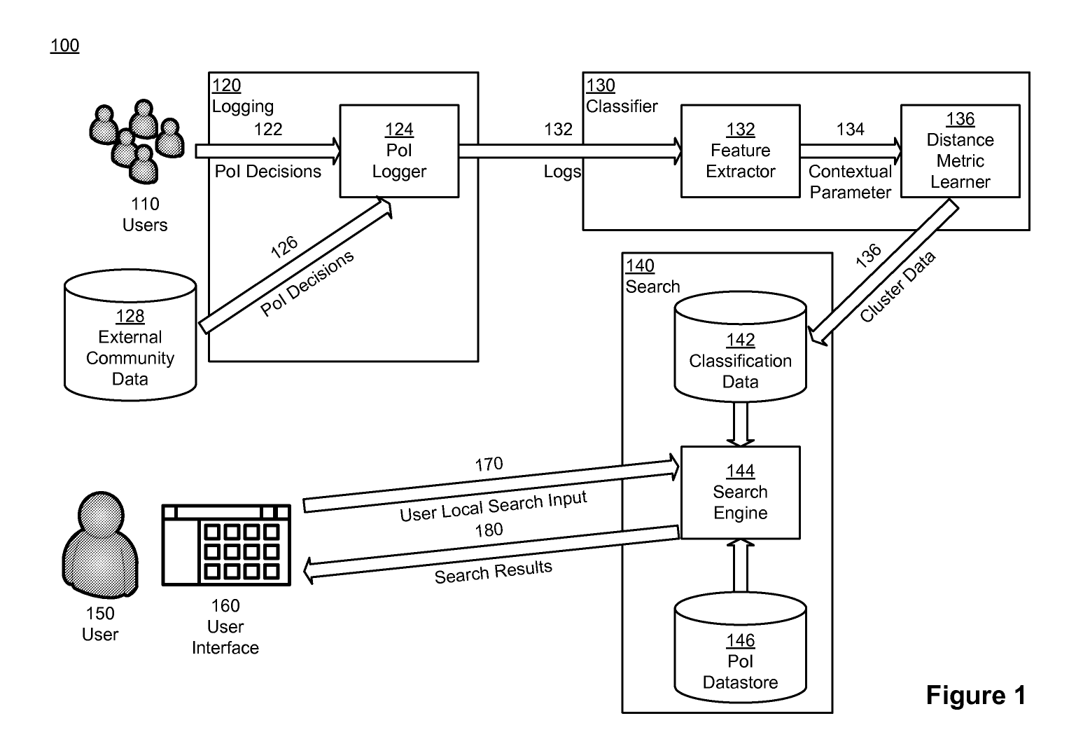

FIG. 1 illustrates an exemplary embodiment of a platform supporting community model 100 based point of interest local search.

In order to create a community model, a set of users 110 is selected from which to obtain community data. A logging function 120 logs point of interest decisions 122 made by users, such as click-through of hyperlinks to point of interest records after a point of interest local search. Specifically, as a user accesses a point of interest search application, when that user selects a point of interest item, that event, along with several predetermined contextual parameters is logged in point of interest logger 124. These access records of a point of interest may be persisted in a log, for example in a user log. External community data 128 may already be captured in some store, perhaps relating to a social network, or alternatively unstructured log data. External community data 128 may be subjected to extract, transform and load routines and access records of point of interest 126 may supplement data in the point of interest logger 124.

Classifier 130 receives one or more logs 132 from the point of interest logger 132, in order to find clusters of data points where a point of interest record was accessed. These clusters correspond to potential sets of like-minded users, or classes. The classifier uses a feature extractor 132 to extract features of a user decision to select a point of interest being accessed. From the extracted features, an access record and its associated context parameters may be extracted.

The records and their contextual parameters 134 are then mapped to a multi-dimensional map where a dimension corresponds to a particular context parameter, in a distance metric learner 136. Specifically, the distance metric learner 136 analyzes the data records to identify clusters, that are data points that are proximate to each other.

The distance metric learner 136 need not rigidly define a cluster as all points within a static radius. The definition of proximate will depend on the distance metric used. For example, Euclidean distance corresponds to a typical linear distance, appropriate for time or other continuous contextual parameters. Other distance metrics may be defined for discontinuous contextual parameters such as category of activity the user is engaged in. Even after a distance metric is identified, a radius defining a cluster may vary under different conditions. For example, a cluster of points of interest for restaurants near work during lunchtime is likely to have a smaller radius, than a cluster of points of tourist attractions, which are likely to be spread out over a locality. In fact, the distance metric learner 136 may adapt its criteria for identifying a cluster based on context and historical data.

Once the distance metric learner 136 has identified clusters, the cluster data 136 is made available to point of interest local search facility 140. Specifically, the cluster data is stored in a classification data store 142. The classification data store 142 data is made available to a point of interest local search engine 144 along with a data store of information about the points of interest themselves 146.

To access search facility 140, a user 150 opens a user interface to a search application 160, perhaps hosted as a web application, or alternatively as a standalone windowed application. The user enters user intent information into user interface 160 which then forwards the user intent information as user local search input 170 to search engine 144. The user local search input 170 contains contextual parameters relating to the user including, but not limited to time of day, day of week and geolocation. Search engine 144 accesses classification data 142 to identify points of interest accessed by past users with a similar set of contextual parameter values. Then the search engine ranks and selects the points of interest most likely to be relevant, and retrieves the details about the corresponding point of interest from point of interest data store 146. These search results 180 are then formatted and presented in the user interface 160 for consumption by user 150.

Optionally, in the event the user selects a point of interest, this information constitutes a point of interest access record. This record may be logged and eventually included as input to the classifier. Alternatively, the record might be uploaded back directly to a classifier 130 to be eventually incorporated with the classification data.

User interface 160 may optionally provide a feedback mechanism for a user 150 to identify false positives. When search results 180 contain irrelevant points of interest, a user may use user interface 160 to mark those records as incorrect, and the user interface may transmit corrective data to the search facility 140 to modify the classification data.

### Exemplary Hardware Environment

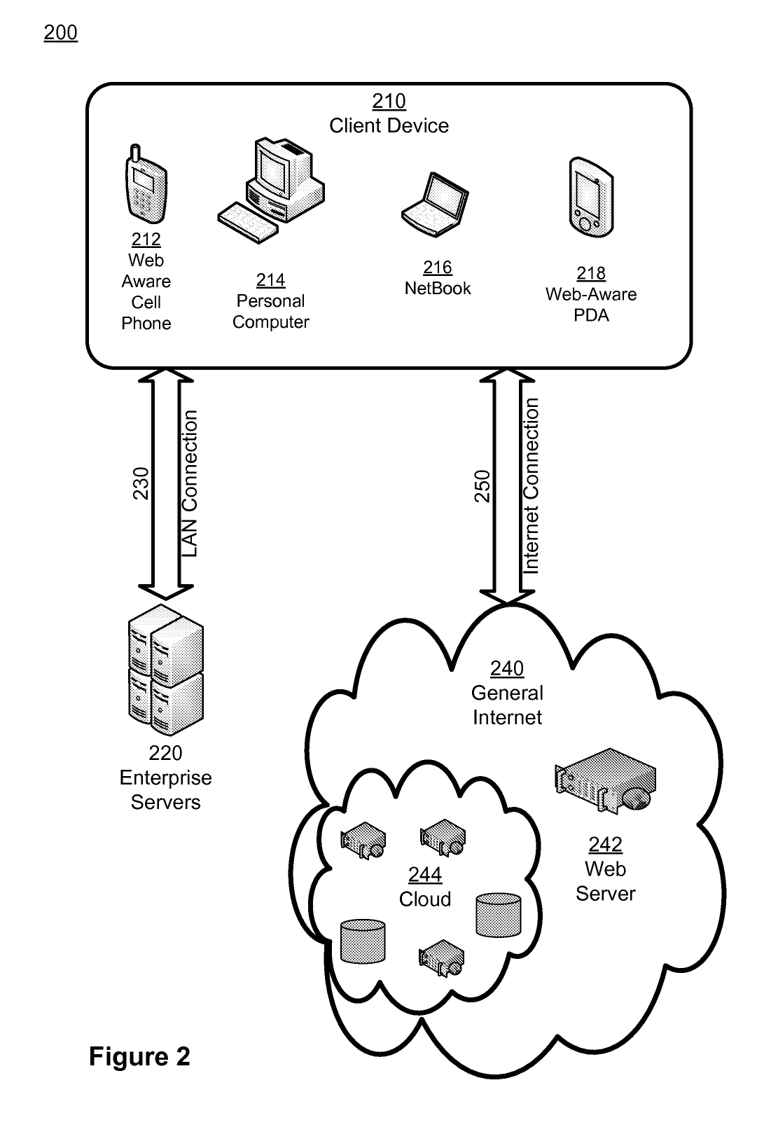

FIG. 2 illustrates an exemplary hardware environment 200 for search based applications. Specifically, FIG. 2 illustrates an exemplary hardware environment 200 to host a community model based point of interest local search.

The community model based point of interest local search application is capable of being hosted on a wide range of client devices 210. If a community model based point of interest local search application is embodied in a web page, the client device may be any web-aware client, including but not limited to a cell phone 212, personal computer (“PC”) 214, netbook 216, or web aware personal device assistant (“PDA”) 218. If the community model based point of interest local search application is embodied in a windowed application, it may be hosted on a PC 214 or netbook 216. PC 214 may include any device of the standard PC architecture, or may include alternative personal computers such as the MacIntosh™ from Apple Computer™, or workstations including but not limited to UNIX workstations.

A community model based point of interest local search application on a client device 210 may then access a search engine or application server hosted on an enterprise server 220 or a server hosted on the general internet 230.

If a community model based point of interest local search application is accessing an enterprise server 220 on a local area network (“LAN”), it may connect via any number of LAN connectivity configurations 230. At the physical layer this may include Ethernet™ or Wi-Fi™ . At the network/session/transport layer this may include connectivity via the Transmission Control Protocol/Internet Protocol (“TCP/IP”) or other protocol. If the community model based point of interest local search application is accessing the internet, it may connect via standard internet protocols including TCP/IP for the network/session/transport layer and Hypertext Transfer Protocol (“HTTP”) at the application layer.

Enterprise server 220 may be based on a standard PC architecture, or on a mainframe.

If accessing the general internet 230, an independently hosted web server 242 may be accessed. A web server 242 may be a standard enterprise server based on a standard PC architecture that hosts an application server. Exemplary application server software includes Internet Information Server™ (“IIS”) from Microsoft Corporation™ or Apache Web Server, an open source application server. Web server 242 may access a database server also potentially on a standard PC architecture hosting a database. Exemplary databases include, Microsoft SQL Server™ and Oracle™. In this way a community model based point of interest local search application may run on 2-tier or 3-tier platforms.

Alternatively, a community model based point of interest local search application or the community model based point of interest local search server infrastructure may be hosted on a cloud computing service 244. Cloud computing service 244 contains a large number of servers and other computing assets potentially in geographically disparate locations. These computing assets may be disaggregated into their constituent CPUs, memory, long term storage, and other component computing assets. Accordingly, the metadata association process, the search engine, and a digital media object data store, when hosted on cloud computing service 244, would have both centralized and distributed data storage on the cloud, accessible via a data access API such as Open Database Connectivity (“ODBC”) or ADO.Net™ from Microsoft Corporation™. A community model based point of interest local search application would be hosted on computing assets in the cloud computing service 244 corresponding to an application server.

### Exemplary Mobile Client

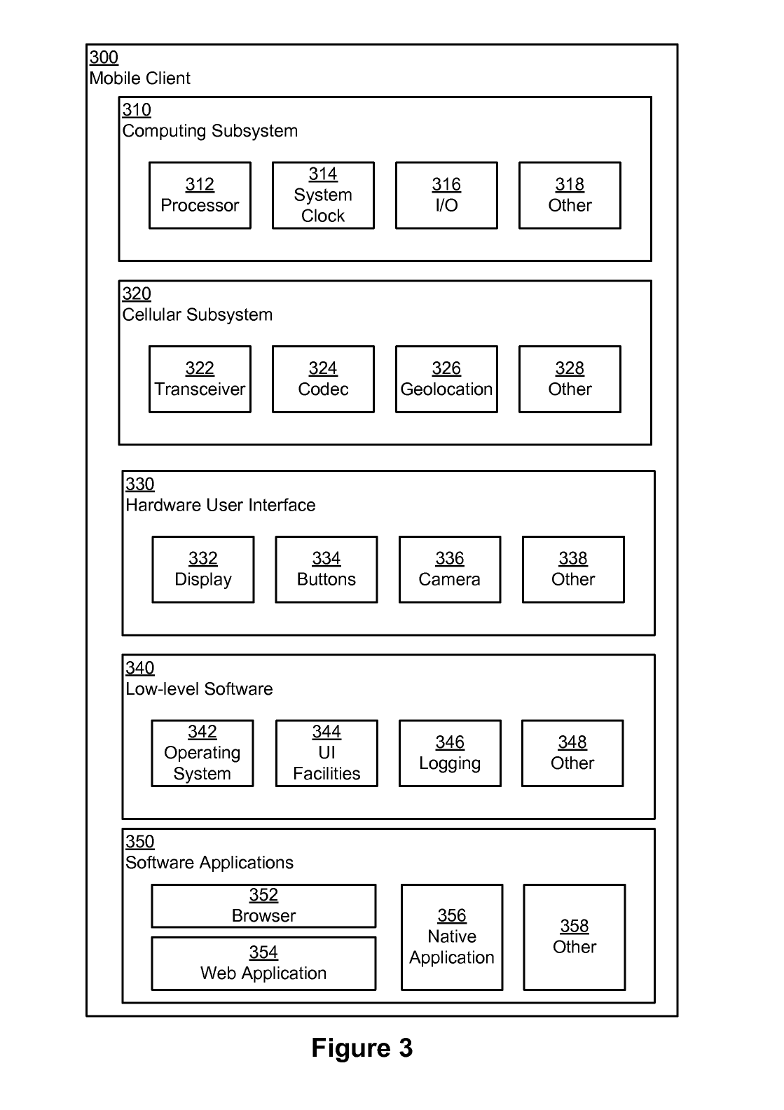

FIG. 3 illustrates an exemplary mobile client 300 for a community model based point of interest local search application. While the present disclosure supports other kinds of clients, both web enabled and otherwise, mobile client 300 covers a common scenario of a portable client that is easily accessible and usually present wherever the user goes.

A canonical example of a mobile client is a cell phone. However, not all cell phones support the necessary functionality for local search. A typical local search enabled mobile client will have cellular communications capability, a clock to indicate time of day and day of week, and a device to determine the user geolocation's. Furthermore, the mobile client will have web browser capability, generally over the cellular communications capability, and the ability to automatically transmit time and geolocation information over the internet and the ability to display, browse and select search results. A mobile client embodiment 300 of this canonical example is a described as follows.

Mobile client 300 comprises a computing subsystem 310, a cellular subsystem 320, a hardware user interface 330, a low-level software layer 340 and various software applications 350.

Computing subsystem 310 includes a processor 312 in the form of a general central processing unit, or alternatively a custom processor. Computing subsystem 310 includes a system clock 314 by which the system may tell time if there is no cellular connectivity. Computing subsystem 316 includes an input/output (I/O) interface for both on-device and extended hardware. Note that both on-device and extended hardware may include sensors to provide information feeds to provide context parameters. An example of an on-device sensor might be a temperature sensor on a mobile device. An example of receiving off-device information might be a heart-rate monitor sending data through the I/O interface. Further note that external data may come from web feeds, for example in the form of a weather report from a web service.

Not shown are other computing subsystem components 318 that comprise a hardware platform. These include, but are not limited to, a system bus, RAM, a boot ROM, and a supporting chipset. A power source, such as a battery (not shown), and a recharger (not shown) are also included in computing subsystem 310.

Cellular subsystem 320 includes all hardware necessary to effect cellular communications. Cellular subsystem 320 includes a transceiver 322 to transmit and receive cellular signals. Transceiver 322 may be supported by one or more custom chips implementing cellular radio functionality. Cellular signals may be coded and decoded by codec 324. A geolocation device 326 may be in the form of a global positioning system (GPS) receiver. Alternative geolocation devices may be in the form of a cellular tower triangulation routine. Other components of the cellular subsystem 328 not shown include an antenna and various routines specific to cellular communications such as quality of service and roaming software.

Hardware user interface 330 includes hardware typically directly accessed by users in the operation of mobile client 300. The hardware user interface 300 includes a display, which may be a simple LCD or LED display, or a touch-screen that may or may not support multi-touch. Buttons 334 may include a 9-pad for dialing phone numbers plus a set of auxiliary buttons to navigate through menus and a software user interface as displayed on the display 332. The hardware user interface 330 may include a camera 336 that may take pictures which may be stored locally or uploaded to a web site via the cellular subsystem 320. Other hardware user interface items 338 not shown include, but are not limited to jog dials, power buttons, Wi-Fi™ interfaces, and the like.

Low-level software 340 encompass the operating system 342 and all other system software that comprise a platform for software applications to run upon. Low-level software 340 may include a library of user interface widgets 344 such as text boxes and radio buttons. Low-level software 340 may also include a logging routine 346 to log internet activity locally. It is this logging routine that may track point of interest local searches, and log user selections. The logs may be stored locally, or uploaded to a web site via the cellular subsystem 320. Other low-level software 340 may include intercepts, journaling hooks, device drivers and other kernel level or device level software.

Software applications 350 may be implemented on top of the low-level software 350. One such software application is a web browser 352. Web browser 352 can run web applications 354 over the cellular subsystem 320. One such web application 354 may be a web based point of interest search client. The web browser 352 usually is one of several native applications 356 resident on mobile client 300. In the alternative, a point of interest search client might be implemented as a native application 356 rather than as a web application 354. In either implementation, web or native, software applications include a search input facility to input search criteria, and a display subsystem to display search results in a formatted manner, to receive a user selection of a search result, to log a selection, and to receive user feedback indicating that a search result is a false positive. Not shown are other software facilities 358 to trap a date and time stamp and the geolocation of the user, and to automatically transmit this information for a point of interest local search application.

### Multi-Dimensional Map and Classification

Turning to the search engine functionality, the present application discloses community based local search. The insight is that similar users in the same context will make similar decisions. If a large amount of user data is organized in such a way as to quickly identify not only similar users, but also similar users in the same context, then points of interest selected by those users are likely relevant to a searching user with those attributes. In the present application, this is accomplished with a multi-dimensional map and classifiers.

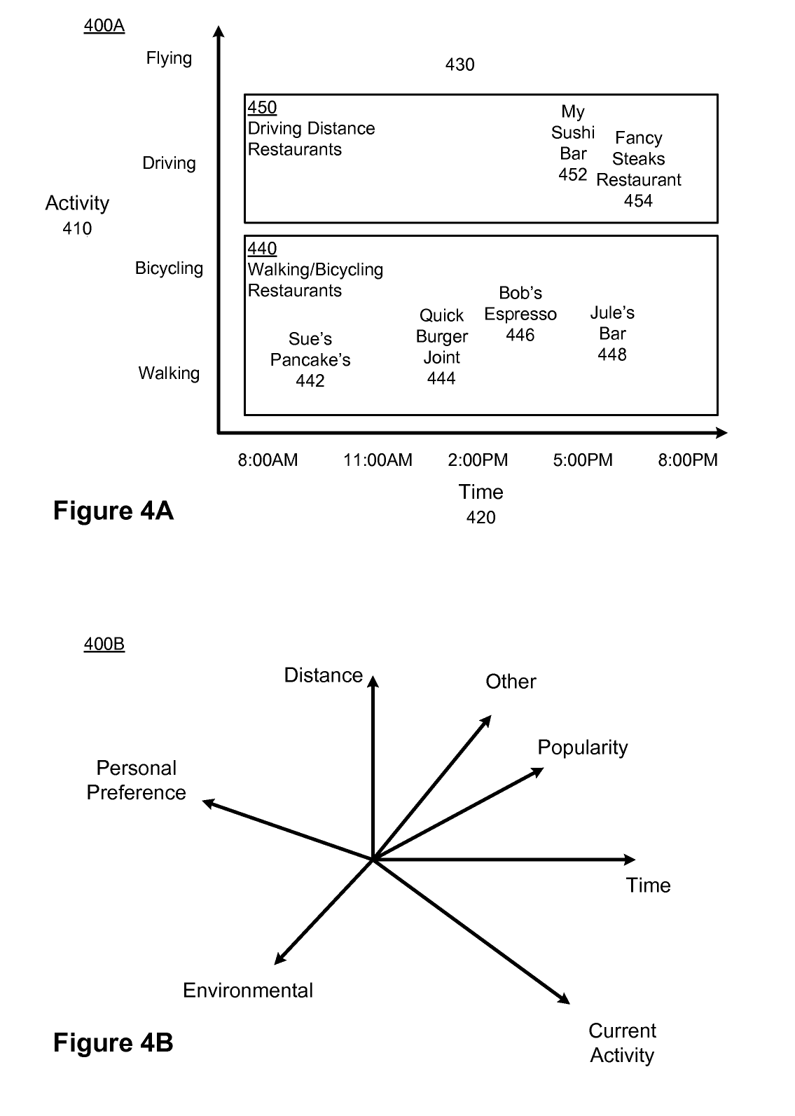

FIG. 4A illustrates a simple multi-dimensional map 400A in two-dimensions. Each dimension corresponds to a contextual parameter. One dimension is user activity 410 comprising whether the user is walking, bicycling, driving or flying. User activity is an example of a category based contextual parameter. While the categories are generally organized in a scale relative to the amount of distance a user may cover, the scale is not necessarily linear. The user activity will affect the distance to a point of interest a user is willing to consider. The second dimension in 400A is time of day 420. While only five times are shown, time of day is a continuum rather than a set of categories.

Access records of points of interest are then mapped to mapping space 430. In this example, various users performed a point of interest search during certain activities and at certain times of the day and selected restaurants. It is important to reiterate that the multi-dimensional map is not a map of points of interest, but rather records that a user selected a point of interest during a point of interest search. In this example, four records show user selections of points of interest during walking or bicycling 440: (1) Sue's Pancakes 442 at 9:00 AM, (2) Quick Burger Joint 444 at 12:30 PM; (3) Bob's Espresso at 446 3:00 PM and (4) Jule's Bar at 448 6:00 PM. Similarly, two records show user selections of points of interest during driving 450: (1) My Sushi Bar 552 at 4:45 PM and (2) Fancy Steaks Restaurant 554 at 6:00 PM.

In practice, a much larger data set with many more dimensions would be mapped. In that situation, it would not be unusual for there to be duplicate selections of a restaurant, either by the same user or by similar users.

A classifier software routine applied to multi-dimensional map 400A would have a distance metric provided by a distance metric learner routine to measure the proximity of records in the map. One example distance metric might be Euclidean space. Another distance metric might be a weighted space. Examples of weightings would be to preferentially weight access records of points of interest by the searching user, by users similar to the searching user, i.e. with similar context parameter values, and by users in the same social network as the searching user. In essence, the purpose of such a weighting scheme would be to appropriately scale and normalize the different dimensions of the multi-dimensional map according to their importance in the selection of points of interest.

The choice of distance metric is dynamically determined by a distance metric learning routine. In some cases, distance metric learning and data point clustering can take place at the same time as an iterative process. Where data points cluster according to the distance metric learning routine, a classifier can determine that the users who made those selections were similar users, i.e. part of the same class. An example might be to consider the My Sushi Bar record 452 and the Fancy Steaks Restaurant 454. Those choices were made nearly at the same time by users while they were driving. These two choices might be considered a cluster, because a distance metric may measure these two choices to be proximate to each other. Accordingly, a classifier software routine may identify this cluster as a class. Note that a classifier may identify a class as comprising more than one cluster. Arguably My Sushi Bar 452 reflects a lighter dinner and Fancy Steaks 454 reflects a heavier and more formal dinner, but a point of interest local search query by a user who was driving at 5:15 PM might fairly return both of these records.

Of course, a user might be allergic to seafood and would consider My Sushi Bar 452 to be a false positive. To increase accuracy, personal preferences, identity of the searching user and other external data may be used to weight the search results.

An alternative way to take other data into account is to expand the multi-dimensional map beyond a mere two dimensions but to a larger number of contextual parameters as shown in FIG. 4B with multi-dimensional map 400B. Here, more than six context parameters are shown in dimensions orthogonal to each other. The six context parameters are distance, personal preferences, environmental conditions (e.g. raining or sunny), current activity (e.g. walking or driving), date time stamp and popularity. Multi-dimensional map 400B need not be limited to these six context parameters, but may also include other context parameters constituting additional dimensions as well.

### Exemplary Server

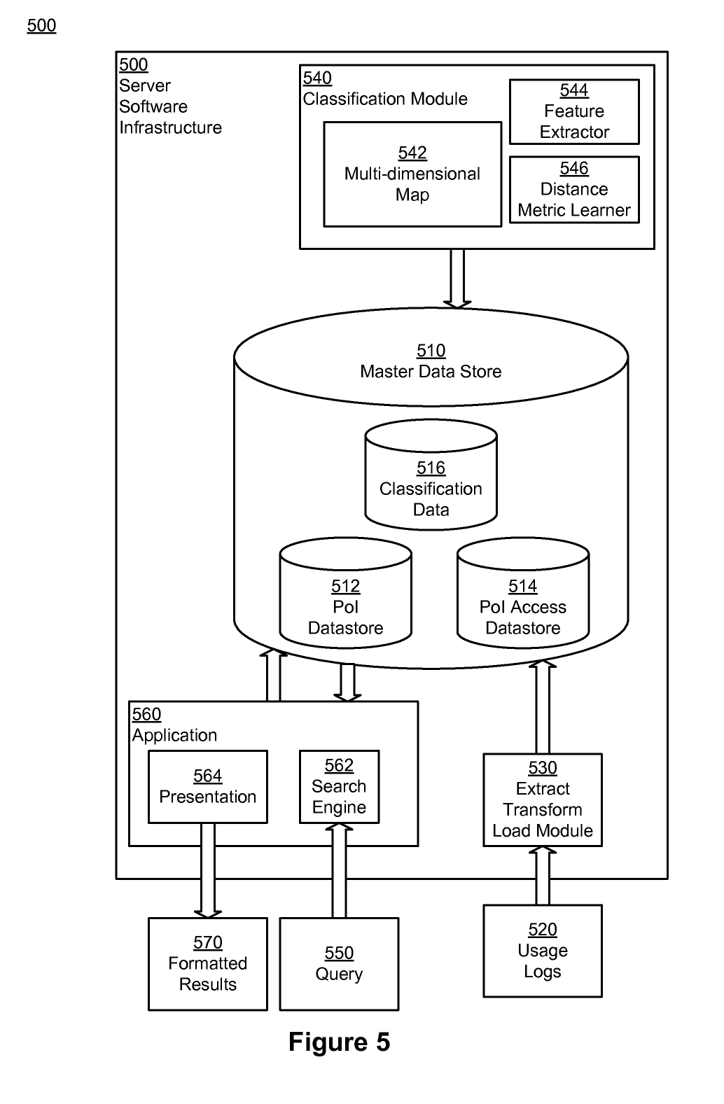

FIG. 5 illustrates an exemplary server software infrastructure 500 supporting a community based point of interest local search application.

A master data store 510 includes, a point of interest data store 512 storing information about particular points of interest, a point of interest access data store 514, storing previous selections by users of a point of interest while performing a point of interest local search, and classification data 516, which organizes the point of interest access records 514 into a set of data records supporting a multi-dimensional map.

The point of interest access data store 514 is populated with usage logs 520 and other external data. Extract, transform and load (ETL) routine 530 extracts out points of interest that were selected and the associated contextual parameters. The contextual parameters may include user information such as date time stamp and geolocation.

Classification module 540 creates and updates multi-dimensional map 542. Specifically, it extracts context parameters, or features, from the point of interest data store, and uses the distance metric learner 546 to identify clusters of data as described with respect to FIGS. 4A and 4B according to a distance metric identified by a distance metric learner.

Users may submit point of interest local search queries 550 to application 560. Here, application 560 is illustrated as a server side web application. Application 560 comprises a search engine 562, which retrieves records that match contextual parameters in the query 550. Search engine 562 may also take other user information into account such as user preferences, and information about social networks and on-line communities that the user may belong to.

Upon receiving search results from the master data store 510, application 560 formats search results with presentation module 564, and provides formatted results 570 to the user. Examples of formatted results are hypertext markup language (HTML) with cascading style sheets (CSS), as well as extensible hypertext markup language (XHTML) with client side script.

### Exemplary Classification Embodiment

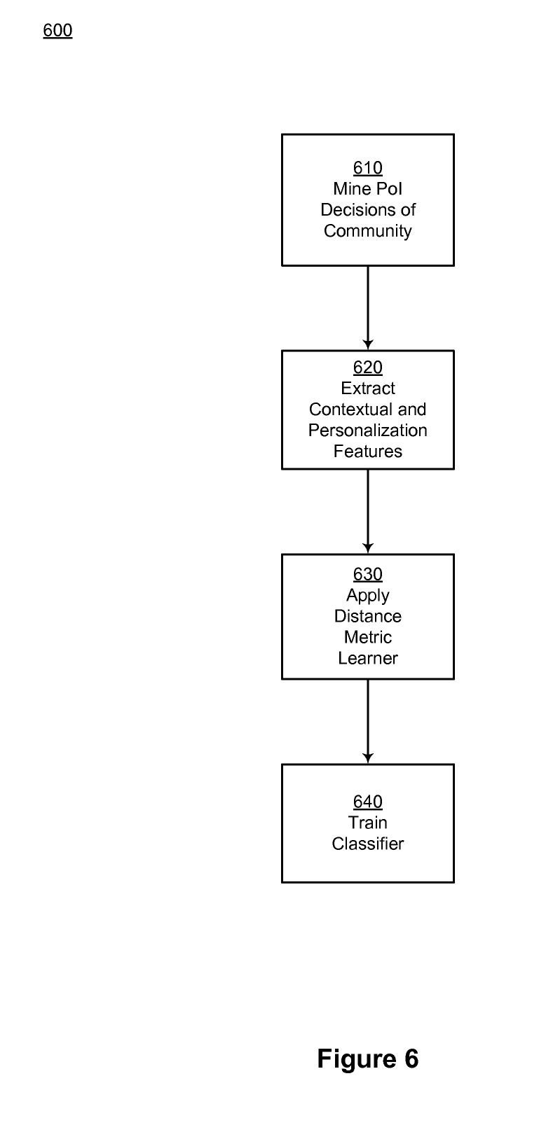

FIG. 6 provides an exemplary embodiment 600 consolidating the previous discussion on identifying clusters of point of interest selections by users with similar contextual parameter values. The clusters of point of interest selections correspond to classes identified by a classifier software routine.

In step 610, the point of interest decisions of a set of users are consolidated and mined. The set of users may be part of the same community. Point of interest decisions may be embodied in the form of usage logs where a point of interest record was selected, or clicked-through while performing a point of interest search.

In step 620, access records of points of interest are extracted from the consolidated point of interest decisions collected in 610. Records coming only from users belonging to a particular community might be extracted. Extracted access records include the point of interest selected as well as contextual parameter information and personal information about the user. Finally, the extracted records may be then transformed into a format suitable for loading into a database.

At this point in time, a distance metric has not yet been determined. Therefore in step 630, a distance metric learner is applied to identify a suitable distance metric. The access records are mapped to a multi-dimensional map, each dimension corresponding to a contextual parameter. Candidate clusters of access records are identified. Note that this process is a fully data driven process and therefore the radius that covers a cluster will vary. Some clusters will be less dense and spread out and accordingly will have a larger radius. Other clusters will be denser and more compact and accordingly will have a smaller radius. Furthermore, what access records comprise a cluster may vary from the context parameters themselves. A cluster may be more compact at the beginning of the day, but less compact at the end of the day. Because the radius of records for a cluster varies, the distance learner applies machine learning and statistical techniques, for example via a large margin nearest neighbor (LMNN) routine, to determine a suitable distance metric.

In step 640, from the clusters of access records and access records, classes are correspondingly identified. The classifier is used to identify what clusters likely comprise a class. Specifically, a machine learning routine or statistical analysis routine, such as a support vector machine (SVM) can analysis the access records and clusters, and identify the probability that a business relates to a set of contextual parameters. A known data set is prepared, that associates clusters and access records with classes. This association data is used to train a classifier. When a statistically significant amount of training data has been applied to the classifier, the classifier may be used to automatically identify classes from clusters identified in step 630. Note that since it is possible for two businesses to be in different clusters yet both have high probability of correlation, it is possible for two clusters to be covered by the same class.

From the foregoing, there are many ways to rank relevance. Suppose that a set of contextual parameter values are received from a query. One possible way to rank whether a business is relevant to a query is to first map the query to the multi-dimensional map according to its contextual parameter values and then to count access records corresponding to businesses proximate to the query contextual parameter values. In this process, all the access records within a predetermined distance threshold defined over the learned distance metric are taken into account. Another possible way is to take advantage of the classes identified by the classifier. Specifically, the classifier calculates the probability that a business is related to a set of contextual parameter values. For example, business X may be ranked at a 90% probability of relevance by the classifier, but business Y may be ranked at a 50% probability of relevance. Accordingly, business X would be ranked higher than business Y. Yet other techniques are available including weighing ranking factors or combining multiple ranking techniques.

### Exemplary Point of Interest Search Embodiment

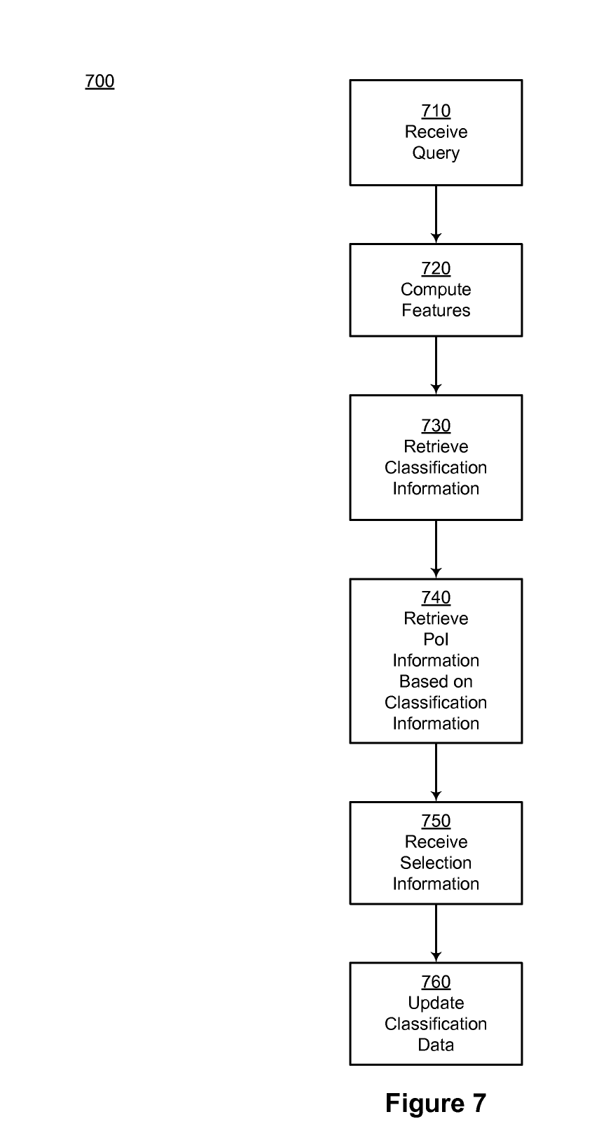

FIG. 7 provides an exemplary embodiment 700 consolidating the previous discussion on point of interest search.

In step 710 a query from a user is received. It may comprise time stamp and geolocation information. It may also comprise additional contextual parameters including, but not limited to, activity, preferences, environment, and external popularity measures.

In step 720, the query is analyzed and features of interest are identified. These features of interest are used to compute a locus of access records corresponding to a multi-dimensional map. In step 730, clusters within the locus of access records likely to be relevant to the user are identified from the classification data. These clusters correspond to classes of interest to the searching user.

In step 740, point of interest selections corresponding to the classes of interest identified in step 730 are then retrieved. These points of interest records may be ranked or scored based on relevance. Relevance may be a function of which records were historically selected by the searching user, records selected by users with similar contextual parameters, users with similar personalization features (i.e. such as an allergy to seafood when selecting restaurants), or any other context parameter of the input query, including, but not limited to time of day, day of week, activity, weather, and traffic conditions. The retrieved records may then be displayed to the searching user for browsing and subsequent selection. The retrieved records are generally displayed substantially in real-time. Specifically the retrieved records are displayed in the same session that the query was received in an on-line and interactive fashion.

Optionally, in step 750, when the browsing user selects a point of interest record, not only is detail information about the point of interest displayed, a user log captures the context parameter values of the user and a record of the selection. This selection may then be stored in a log for subsequent upload for classification at a later time 760. Alternatively, the selection may be immediately uploaded for classification 760. The user might also optionally provide feedback as to whether some of the points of interest data were false positives. Such indications may be performed as part of the user interface of a client application.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method to perform a local point of interest search, the method comprising:
extracting values of predetermined contextual parameters of a query from a user, the contextual parameters relating to the user's intent;
accessing one or more entries in a data store, each entry being a prior selected local search query result comprised of a point of interest and a decision by a user to select the point of interest, mapped to a multi-dimensional map indicating relevance of at least one of the predetermined contextual parameters; and
presenting an entry of the data store based at least on a calculated similarity between the extracted values of predetermined contextual parameters from the query and the entry to be presented.

2. The method of claim 1, wherein at least one of the predetermined contextual parameters is chosen from the group of:
a demographic attribute of the user;
a non-demographic attribute of the user;
an attribute of a local search query result; and
a global attribute.

3. The method of claim 1, wherein at least one of the entries in the data store is a point of interest, the point of interest being chosen from the group of:
a place of business;
a private residence;
a tourist attraction; and
a government installation.

4. The method of claim 1, the method further comprising:
extracting a distance metric across all dimensions of the multi-dimensional map, from the local search query results mapped to the multi-dimensional map, using a distance metric learner;
calculating a similarity between the extracted query values and an entry in the data store based at least on the extracted distance metric; and
identifying clusters of local search query results in the multi-dimensional map based at least on the extracted distance metric

5. The method of claim 4, the method further comprising:
identifying classes comprised of the identified clusters using a trained classifier of points of interest, the identifying classes based at least on calculating the probability that the point of interest of an entry is relevant to a set of contextual parameters.

6. The method of claim 4, wherein the entry is comprised of a click-through result from a search log.

7. The method of claim 4, wherein one of the predetermined contextual parameters is an identity of the user entering the query, and the calculated similarity is weighted to favor click-throughs performed by the user who entered the query.

8. The method of claim 4, wherein at least one of the predetermined contextual parameters relates to a user profile of a user entering the query, and the calculated similarity is weighted to favor click-throughs performed by users with similar user profiles.

9. The method of claim 8, further comprising:
determining whether a user profile is similar to that of the user entering a query based on a predetermined distance metric for at least one of the predetermined contextual parameters that relates to the user profile.

10. The method of claim 8, further comprising:
determining whether a user profile is similar to that of the user entering a query if the user profile describes a social network to which the user entering the query belongs.

11. The method of claim 1, wherein the method further comprises:
receiving a selection of a presented entry; and
storing the selection.

12. The method of claim 4, wherein the presenting further comprises:
ranking the entries of the data store to be presented based at least on part of the extracted distance metric.

13. The method of claim 1, the method further comprising receiving a query from a user; and
wherein the presenting an entry of the data store is performed in the same session that the query from the user was received.

14. A method to train a classifier of points of interest, the method comprising:
receiving a set of access records for points of interest, each access record comprising a point of interest identifier and values corresponding to a set of predetermined contextual parameters;
creating a multi-dimensional map of the access records, at least one dimension of the multi-dimensional map being one of the predetermined contextual parameters;
mapping the set of access records to the created multi-dimensional map; and
identifying classes comprised of the points of interest in the access records, using a trained classifier of points of interest, the identifying classes based at least on calculating the probability that the point of interest of an entry is relevant to a set of contextual parameters.

15. The method of claim 14, wherein the received set of access records comprises a user search log.

16. The method of claim 14, wherein the identifying clusters of points in the map comprises:
extracting a distance metric across all dimensions of the multi-dimensional map, from the local search query results mapped to the multi-dimensional map, using a distance metric learner; and
identifying clusters of local search query results in the multi-dimensional map based at least on the extracted distance metric.

17. The method of claim 14, further comprising:
storing the access records and a respective location of a point of interest in the multi-dimensional map;
storing the identified clusters in a data store; and
storing an indexing link between each access record and its respective identified cluster.

18. The method of claim 14, wherein at least one dimension of the multi-dimensional map is a contextual parameter derived from a user being associated with a social network.

19. The method of claim 14, further comprising:
receiving a new access record for a point of interest;
mapping the new access record to the multi-dimensional map;
modifying the identified clusters of points in the map to reflect the new mapped access record; and
identifying new clusters of points in the map that were created from the mapping of the new access record.

20. A mobile system to obtain point-of-interest information, the system comprising:
a cellular communications subsystem;
one or more sensors;
an input/output interface;
a point of interest search input facility that sends to an on-line point of interest search service predetermined contextual parameters based on information received from any one of:
at least one sensor,
an external sensor accessed via the input/output interface, and
a web service accessed via the cellular communications subsystem; and
a point of interest display subsystem, that displays point of interest information comprising one or more point of interest records received by the system.
